(19) United States
(12) Patent Application Publication
(10) Pub. No.: US 2026/0269137 A1
(43) Pub. Date: Sep. 10, 2026

(54) ELECTRONIC COMPONENT

(71) Applicant: TDK Corporation, Tokyo (JP)

(72) Inventors: Atsuhiro TSUYOSHI, Tokyo (JP); Yu FUKAE, Tokyo (JP); Takashi OHTSUKA, Tokyo (JP); Yoshinori UCHIYAMA, Tokyo (JP); Takeshi OOHASHI, Tokyo (JP); Yusuke TAKIGUCHI, Tokyo (JP)

(73) Assignee: TDK Corporation, Tokyo (JP)

(21) Appl. No.: 19/557,679

(22) Filed: Mar. 5, 2026

(30) Foreign Application Priority Data
Mar. 7, 2025 (JP) 2025-036467

(51) Int. Cl. H01G 4/33; H01G 4/012; H01G 4/224; H01G 4/236; H01G 17/00

(52) U.S. Cl. CPC H01G 4/33; H01G 4/012; H01G 4/224; H01G 4/236; H01G 17/00

(57) ABSTRACT

An electronic component includes a substrate, and an element body disposed on the substrate, in which the element body is configured to include a plurality of conductor layers and insulating layers, the plurality of conductor layers include a first conductor layer disposed on the substrate and a second conductor layer disposed on the first conductor layer, the first conductor layer includes a plurality of first conductor patterns, the second conductor layer includes a second conductor pattern, the first conductor pattern and the second conductor pattern are electrically connected by a first connection conductor, a first protruding portion is provided in the second conductor pattern, and the first protruding portion of the second conductor pattern is disposed in the insulating layer positioned between two adjacent first conductor patterns.

### TECHNICAL FIELD

The present disclosure relates to an electronic component.

### BACKGROUND

Japanese Unexamined Patent Publication No. 2021-101480 discloses an electronic component including a substrate, a lower electrode formed on the substrate, a dielectric film formed on the lower electrode, an upper electrode formed of a metal or a conductor containing a metal on a part of the dielectric film, a protective layer formed of a resin material and covering the lower electrode and the upper electrode, a first external electrode penetrating the protective layer and connected to the upper electrode, and a second external electrode penetrating the protective layer and the dielectric film and connected to the lower electrode, in which in a plan view of a capacitor from above, the first external electrode is formed only within a region defined by a peripheral edge of the upper electrode, and the second external electrode is provided in contact with the dielectric film.

### SUMMARY

An electronic component according to one aspect of the present disclosure includes a substrate, and an element body disposed on the substrate, in which the element body is configured to include a plurality of conductor layers and insulating layers, the plurality of conductor layers include a first conductor layer disposed on the substrate and a second conductor layer disposed on the first conductor layer, the first conductor layer includes a plurality of first conductor patterns, the second conductor layer includes a second conductor pattern, the first conductor pattern and the second conductor pattern are electrically connected by a first connection conductor, a first protruding portion is provided in the second conductor pattern, and the first protruding portion of the second conductor pattern is disposed in the insulating layer positioned between two adjacent first conductor patterns.

### BRIEF DESCRIPTION OF THE DRAWINGS

FIG. 1 is a perspective view of an electronic component according to one embodiment.

FIGS. 2A, 2B, and 2C are views illustrating respective layers constituting an element body.

FIGS. 3A, 3B, and 3C are views illustrating respective layers constituting the element body.

FIGS. 4A, 4B, and 4C are views illustrating respective layers constituting the element body.

FIGS. 5A and 5B are views illustrating respective layers constituting the element body.

FIG. 6 is an enlarged cross-sectional view illustrating a part of the electronic component.

FIG. 7 is an enlarged cross-sectional view illustrating a part of the electronic component.

FIGS. 8A, 8B, and 8C are views schematically illustrating a part of a manufacturing process of the electronic component.

FIG. 9 is an enlarged cross-sectional view illustrating a part of an electronic component according to another embodiment.

FIG. 10 is an enlarged cross-sectional view illustrating a part of the electronic component according to another embodiment.

### DETAILED DESCRIPTION

### Technical Problem

In electronic components, a conductor is covered with a resin (protective layer). In electronic components, when a volume of the resin increases, there is a likelihood that conductors may peel from each other due to stress (thermal expansion) caused by a difference in expansion coefficient between the conductors and the resin.

An objective of one aspect of the present disclosure is to provide an electronic component in which peeling of conductors can be suppressed.

### Effect of this disclosure

According to one aspect of the present disclosure, peeling of conductors can be suppressed.

### Description of an embodiment of this disclosure

First, contents of embodiments of the present disclosure will be listed and described. At least a part of the embodiments described below may be arbitrarily combined.

(1) An electronic component according to one aspect of the present disclosure includes a substrate, and an element body disposed on the substrate, in which the element body is configured to include a plurality of conductor layers and insulating layers, the plurality of conductor layers include a first conductor layer disposed on the substrate and a second conductor layer disposed on the first conductor layer, the first conductor layer includes a plurality of first conductor patterns, the second conductor layer includes a second conductor pattern, the first conductor pattern and the second conductor pattern are electrically connected by a first connection conductor, a first protruding portion is provided in the second conductor pattern, and the first protruding portion of the second conductor pattern is disposed in the insulating layer positioned between two adjacent first conductor patterns.

In the electronic component according to one aspect of the present disclosure, the first protruding portion of the second conductor pattern is disposed in the insulating layer positioned between the two adjacent first conductor patterns. In this way, in the electronic component, since the first protruding portion of the second conductor pattern is positioned in the insulating layer between the two adjacent first conductor patterns, a volume of the insulating layer is reduced. Thereby, in the electronic component, stress caused by a difference in expansion coefficient between the conductor and the insulating layer can be reduced. Therefore, in the electronic component, peeling of the first connection conductor, which connects the first conductor pattern and the second conductor pattern, due to the stress can be suppressed.

(2) In the electronic component of (1) described above, in the two adjacent first conductor patterns, one first conductor pattern and the other first conductor pattern may constitute different elements, respectively.

(3) In the electronic component of (1) or (2) described above, the first protruding portion may have a shape that tapers from a base end toward a distal end. That is, the first protruding portion is wider on the base end side than on the distal end side. The first protruding portion is formed by forming, in the insulating layer, a recessed portion having a shape corresponding to the first protruding portion, forming a seed layer in the recessed portion, and forming a plated conductor on the seed layer. In this manufacturing method, when the first protruding portion is formed to have a shape that tapers from the base end toward the distal end, the recessed portion also has a shape that tapers from an opening toward a bottom surface. In this case, the seed layer is appropriately (uninterruptedly) formed in the recessed portion. Therefore, the first protruding portion is appropriately formed.

(4) In the electronic component of any one of (1) to (3) described above, at least a part of the first protruding portion may be positioned between the two adjacent first conductor patterns. With this configuration, a volume of the insulating layer is further reduced. Therefore, in the electronic component, peeling of the connection conductor, which connects the first conductor pattern and the second conductor pattern, due to the stress can be further suppressed.

(5) In the electronic component of any one of (1) to (4) described above, the first protruding portion may be formed to have a curved surface.

(6) In the electronic component of any one of (1) to (5) described above, a distance between the first protruding portion and the substrate may be 8 μm or more and 18 μm or less.

(7) In the electronic component of any one of (1) to (6) described above, a distance between the two adjacent first conductor patterns may be 15 μm or more and 50 μm or less.

(8) In the electronic component of any one of (1) to (7) described above, the plurality of conductor layers may include a third conductor layer disposed on the second conductor layer, the second conductor layer may include a plurality of second conductor patterns, the third conductor layer may include a third conductor pattern, the second conductor pattern and the third conductor pattern may be electrically connected by a second connection conductor, a second protruding portion may be provided in the third conductor pattern, and the second protruding portion of the third conductor pattern may be disposed in the insulating layer positioned between two adjacent second conductor patterns. With this configuration, peeling of the second connection conductor, which connects the second conductor pattern and the third conductor pattern, due to the stress can be suppressed.

(9) In the electronic component of (3) described above, at least a part of the first protruding portion may be positioned between the two adjacent first conductor patterns.

(10) In the electronic component of (4) described above, a distal end of the first protruding portion may be positioned on the substrate side with respect to a surface of the first conductor pattern.

(11) In the electronic component of any one of (1) to (10) described above, a distal end of the first protruding portion may be positioned on the second conductor layer side with respect to a surface of the first conductor pattern.

(12) In the electronic component of (8) described above, the second protruding portion may have a shape that tapers from a base end toward a distal end.

(13) In the electronic component of (8) described above, at least a part of the second protruding portion may be positioned between the two adjacent second conductor patterns.

(14) In the electronic component of (8) described above, the second protruding portion may be formed to have a curved surface.

(15) In the electronic component of any one of (1) to (14) described above, the insulating layer may be formed of a resin including bisphenol F.

(16) The electronic component of any one of (1) to (15) described above may further include a planar layer disposed between the substrate and the element body.

(17) The electronic component of any one of (1) to (16) described above may further include an adhesion layer disposed on the first conductor layer and covering the first conductor pattern.

(18) The electronic component of any one of (1) to (17) described above may further have a capacitor pattern disposed between the first conductor layer and the second conductor layer and constituting a capacitor together with the first conductor pattern.

(19) In the electronic component of any one of (1) to (18) described above, the first connection conductor may be a via conductor.

(20) In the electronic component of any one of (1) to (19) described above, the electronic component may be a band-pass filter.

### Details of the embodiments of this disclosure

A specific example of an embodiment of the present disclosure will be described below with reference to the drawings. The present disclosure is not limited to these examples, but is defined by the scope of the claims, and is intended to include all modifications within the meaning and scope equivalent to the claims. In the description of the drawings, the same elements will be denoted by the same reference signs, and duplicate description thereof will be omitted.

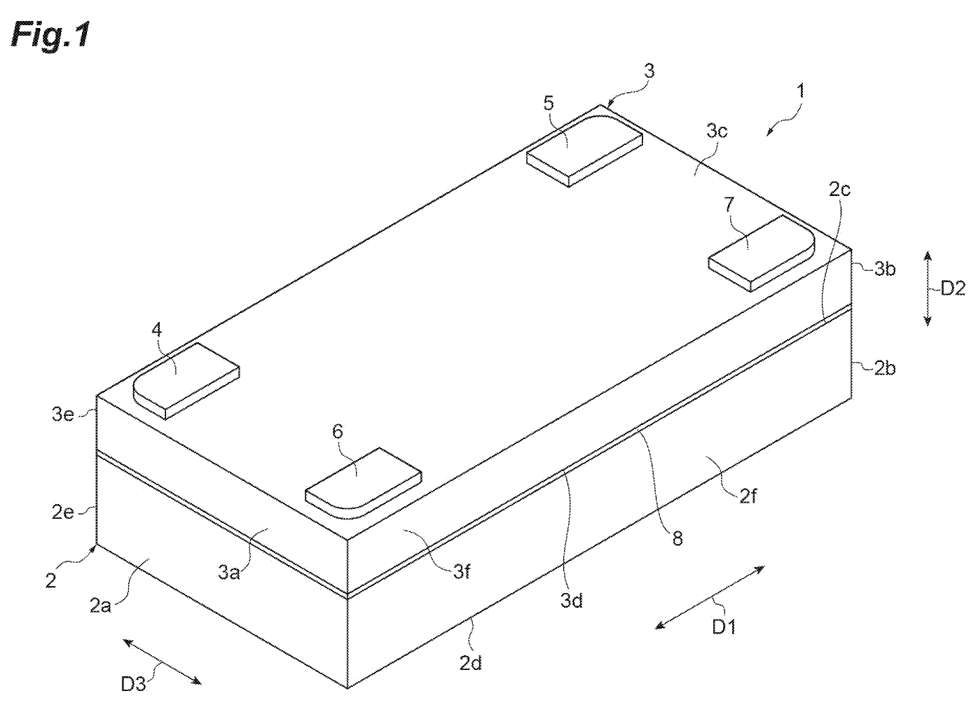

FIG. 1 is a perspective view of an electronic component according to one embodiment. As illustrated in FIG. 1, an electronic component 1 includes a substrate 2, an element body 3, and a first terminal electrode 4, a second terminal electrode 5, a third terminal electrode 6, and a fourth terminal electrode 7 that are disposed on the element body 3. The electronic component 1 is, for example, a band-pass filter.

The substrate 2 has a rectangular parallelepiped shape. The rectangular parallelepiped shape includes a rectangular parallelepiped shape in which corner portions and ridge portions are chamfered, and a rectangular parallelepiped shape in which corner portions and ridge portions are rounded. The substrate 2 has, as outer surfaces thereof, a pair of end surfaces 2a and 2b facing each other, a pair of main surfaces 2c and 2d facing each other, and a pair of side surfaces 2e and 2f facing each other.

A facing direction in which the pair of end surfaces 2a and 2b face each other is a first direction D1. A facing direction in which the pair of main surfaces 2c and 2d face each other is a second direction D2. A facing direction in which the pair of side surfaces 2e and 2f face each other is a third direction D3. In the present embodiment, the first direction D1 is a longitudinal direction of the substrate 2. The second direction D2 is a height direction of the substrate 2 and is orthogonal to the first direction D1. The third direction D3 is a width direction of the substrate 2 and is orthogonal to the first direction D1 and the second direction D2.

The pair of end surfaces 2a and 2b extend in the second direction D2 to connect between the pair of main surfaces 2c and 2d. The pair of end surfaces 2a and 2b also extend in the third direction D3. The pair of side surfaces 2e and 2f extend in the second direction D2 to connect between the pair of main surfaces 2c and 2d. The pair of side surfaces 2e and 2f also extend in the first direction D1.

The substrate 2 is formed of a material that is chemically and thermally stable, generates little stress, and is capable of maintaining smoothness of a surface thereof. The material is not particularly limited, and single crystal silicon, alumina, sapphire, aluminum nitride, single crystal MgO, single crystal SrTiO₃, surface-oxidized silicon, glass, quartz, and ferrite, or the like can be used.

The element body 3 has a rectangular parallelepiped shape. The element body 3 has, as outer surfaces thereof, a pair of end surfaces 3a and 3b facing each other, a pair of main surfaces 3c and 3d facing each other, and a pair of side surfaces 3e and 3f facing each other. The pair of end surfaces 3a and 3b face each other in the first direction D1. The pair of main surfaces 3c and 3d face each other in the second direction D2. The pair of side surfaces 3e and 3f face each other in the third direction D3. In the electronic component 1, the main surface 3c constitutes a mounting surface that faces an electronic device or the like.

The pair of end surfaces 3a and 3b extend in the second direction D2 to connect between the pair of main surfaces 3c and 3d. The pair of end surfaces 3a and 3b also extend in the third direction D3. The pair of side surfaces 3e and 3f extend in the second direction D2 to connect between the pair of main surfaces 3c and 3d. The pair of side surfaces 3e and 3f also extend in the first direction D1. A dimension of the element body 3 in the first direction D1 is equal to a dimension of the substrate 2 in the first direction D1. A dimension of the element body 3 in the third direction D3 is equal to a dimension of the substrate 2 in the third direction D3.

Further, in the present embodiment, the term “equal” includes not only being equal but also values including slight differences or manufacturing tolerances within a preset range. For example, if a plurality of values fall within a range of ±5% of an average value of the plurality of values, the plurality of values are defined as being equal.

The substrate 2 and the element body 3 are provided integrally. The substrate 2 and the element body 3 are disposed such that the main surface 2c and the main surface 3d face each other. A planar layer 8 is disposed between the substrate 2 and the element body 3. The planar layer 8 is disposed between the main surface 2c of the substrate 2 and the main surface 3d of the element body 3. As the planar layer 8, alumina, silicon oxide, or the like can be used.

The first terminal electrode 4, the second terminal electrode 5, the third terminal electrode 6, and the fourth terminal electrode 7 are disposed on the main surface 3c of the element body 3. The first terminal electrode 4, the second terminal electrode 5, the third terminal electrode 6, and the fourth terminal electrode 7 each have a substantially rectangular shape in a plan view. The rectangular shape includes a shape in which corner portions and ridge portions are chamfered, and a shape in which corner portions and ridge portions are rounded. In the present embodiment, the first terminal electrode 4, the second terminal electrode 5, the third terminal electrode 6, and the fourth terminal electrode 7 each have a shape in which one corner portion is rounded (curved).

The first terminal electrode 4 is disposed at a position closer to the end surface 3a and closer to the side surface 3e. The second terminal electrode 5 is disposed at a position closer to the end surface 3b and closer to the side surface 3e. The third terminal electrode 6 is disposed at a position closer to the end surface 3a and closer to the side surface 3f. The fourth terminal electrode 7 is disposed at a position closer to the end surface 3b and closer to the side surface 3f.

The first terminal electrode 4 and the second terminal electrode 5 are disposed with a spacing therebetween in the first direction D1. The third terminal electrode 6 and the fourth terminal electrode 7 are disposed with a spacing therebetween in the first direction D1. The first terminal electrode 4 and the third terminal electrode 6 are disposed with a spacing therebetween in the third direction D3. The second terminal electrode 5 and the fourth terminal electrode 7 are disposed with a spacing therebetween in the third direction D3. The spacing between the respective terminal electrodes may be appropriately selected according to specifications required for the electronic component 1.

The first terminal electrode 4, the second terminal electrode 5, the third terminal electrode 6, and the fourth terminal electrode 7 can be formed of an appropriate conductor (for example, gold, nickel, copper, silver, or the like).

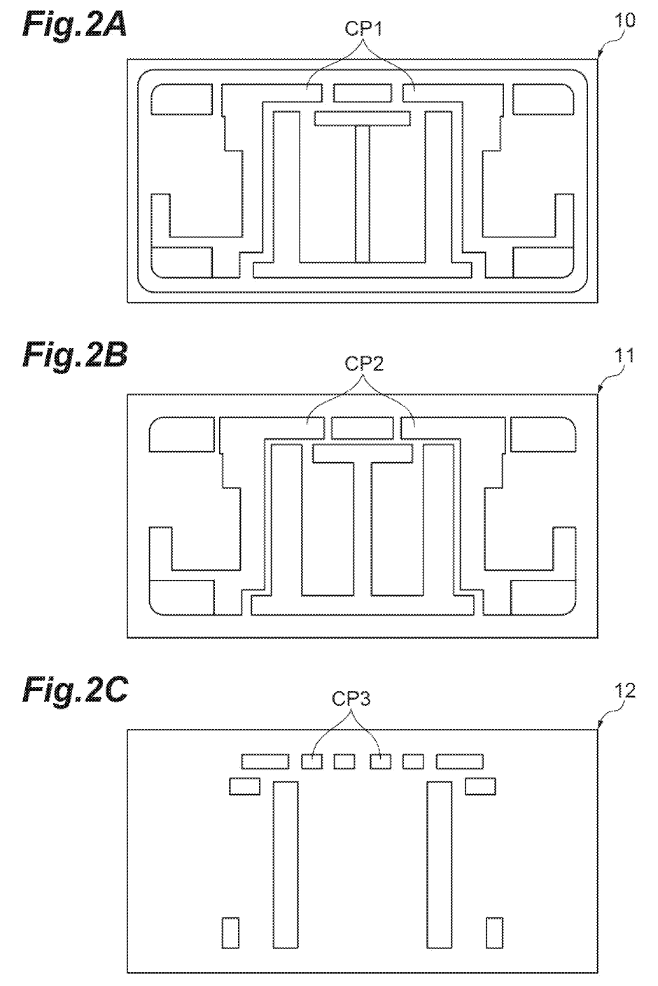

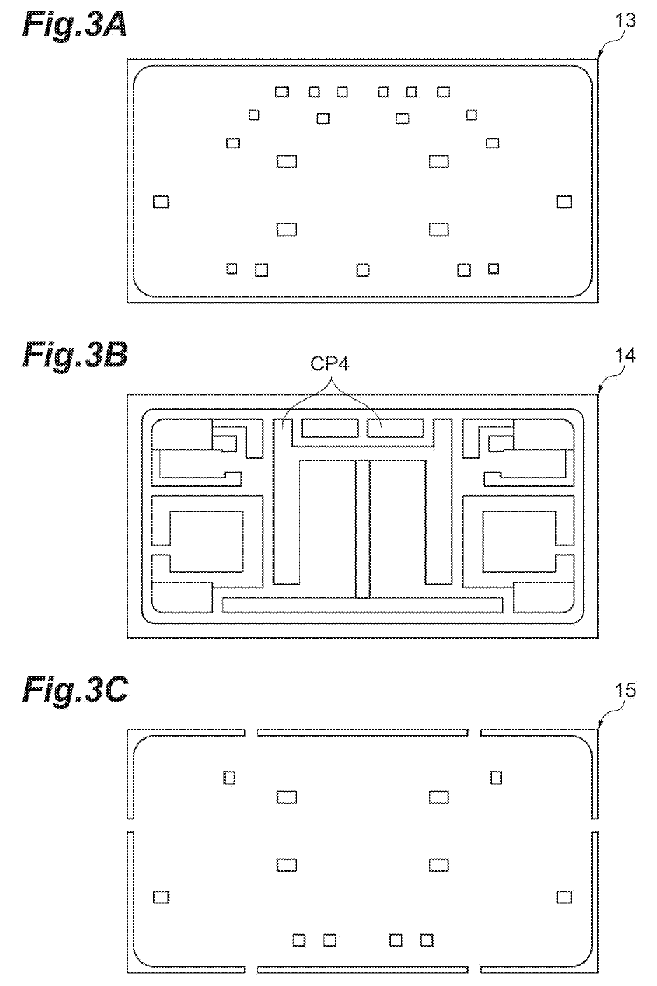

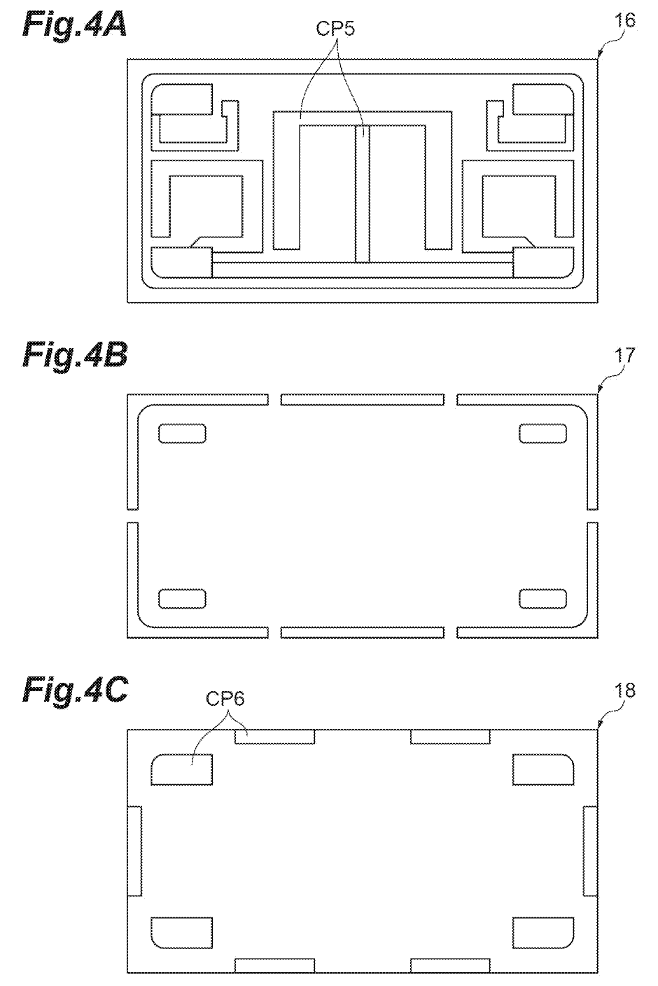

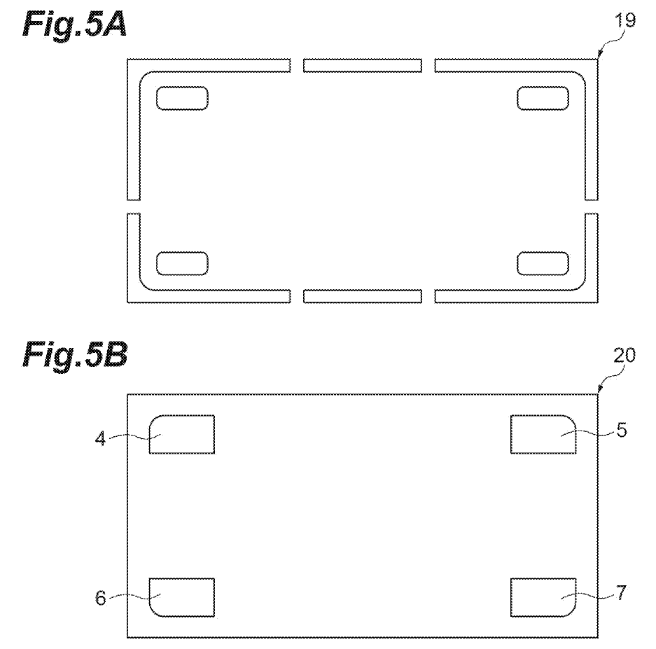

FIGS. 2A, 2B, and 2C are views illustrating respective layers constituting the element body 3. FIGS. 3A, 3B, and 3C are views illustrating respective layers constituting the element body 3. FIGS. 4A, 4B, and 4C are views illustrating respective layers constituting the element body 3. FIGS. 5A and 5B are views illustrating respective layers constituting the element body 3.

As illustrated in FIGS. 2A, 2B, and 2C, FIGS. 3A, 3B, and 3C, FIGS. 4A, 4B, and 4C, and FIGS. 5A and 5B, the element body 3 is configured to include a first conductor layer 10, an intermediate layer (adhesion layer) 11, an electrode layer 12, a first insulating layer 13, a second conductor layer 14, a second insulating layer 15, a third conductor layer 16, a third insulating layer 17, a fourth conductor layer 18, a fourth insulating layer 19, and a terminal layer 20. The first conductor layer 10, the intermediate layer 11, the electrode layer 12, the first insulating layer 13, the second conductor layer 14, the second insulating layer 15, the third conductor layer 16, the third insulating layer 17, the fourth conductor layer 18, the fourth insulating layer 19, and the terminal layer 20 are disposed in different layers from each other in the second direction D2. In the actual element body 3, the first insulating layer 13, the second insulating layer 15, the third insulating layer 17, and the fourth insulating layer 19 are integrated to such an extent that boundaries between the layers are not visually recognizable.

The first conductor layer 10 is disposed on the substrate 2. The first conductor layer 10 includes a plurality of first conductor patterns CP1. Each of the first conductor patterns CP1 can be formed of an appropriate conductor (for example, copper or the like).

The intermediate layer 11 is disposed on the first conductor layer 10. The intermediate layer 11 covers the first conductor layer 10. The intermediate layer 11 includes a plurality of patterns CP2. Each of the plurality of patterns CP2 covers a corresponding one of the plurality of first conductor patterns CP1 of the first conductor layer 10. The patterns CP2 can be formed of chromium, titanium, tantalum, titanium nitride, tantalum nitride, or the like.

The electrode layer 12 is disposed on the intermediate layer 11. The electrode layer 12 includes a plurality of capacitor patterns CP3. Each of the capacitor patterns CP3 can be formed of an appropriate conductor (for example, copper or the like). The capacitor pattern CP3 is connected to a second conductor pattern CP4 (to be described later) of the second conductor layer 14, and together with the first conductor patterns CP1 of the first conductor layer 10, forms a capacitor.

The first insulating layer 13 covers the first conductor layer 10. In the present embodiment, the first insulating layer 13 is made of bisphenol F That is, the element body 3 is formed to include a resin of bisphenol F. Bisphenol F has lower viscosity and is a softer material than conventional bisphenol A, and therefore generates lower stress, making it possible to suppress peeling of the insulating layer from the substrate. The first insulating layer 13 constitutes the main surface 3d of the element body 3.

The second conductor layer 14 includes a plurality of second conductor patterns CP4. Each of the second conductor patterns CP4 can be formed of an appropriate conductor (for example, copper or the like).

The second insulating layer 15 covers the second conductor layer 14. In the present embodiment, the second insulating layer 15 is made of bisphenol F

The third conductor layer 16 includes a plurality of third conductor patterns CP5. Each of the third conductor patterns CP5 can be formed of an appropriate conductor (for example, copper or the like).

The third insulating layer 17 covers the third conductor layer 16. The third insulating layer 17 is made of bisphenol F

The fourth conductor layer 18 includes a plurality of fourth conductor patterns CP6. Each of the fourth conductor patterns CP6 can be formed of an appropriate conductor (for example, copper or the like).

The fourth insulating layer 19 covers the fourth conductor layer 18. The fourth insulating layer 19 is made of bisphenol F The fourth insulating layer 19 constitutes the main surface 3c of the element body 3.

The terminal layer 20 includes the first terminal electrode 4, the second terminal electrode 5, the third terminal electrode 6, and the fourth terminal electrode 7.

In the electronic component 1, an inductor and a capacitor are constituted by the first conductor patterns CP1 of the first conductor layer 10, the capacitor patterns CP3 of the electrode layer 12, the second conductor patterns CP4 of the second conductor layer 14, the third conductor patterns CP5 of the third conductor layer 16, and the fourth conductor patterns CP6 of the fourth conductor layer 18.

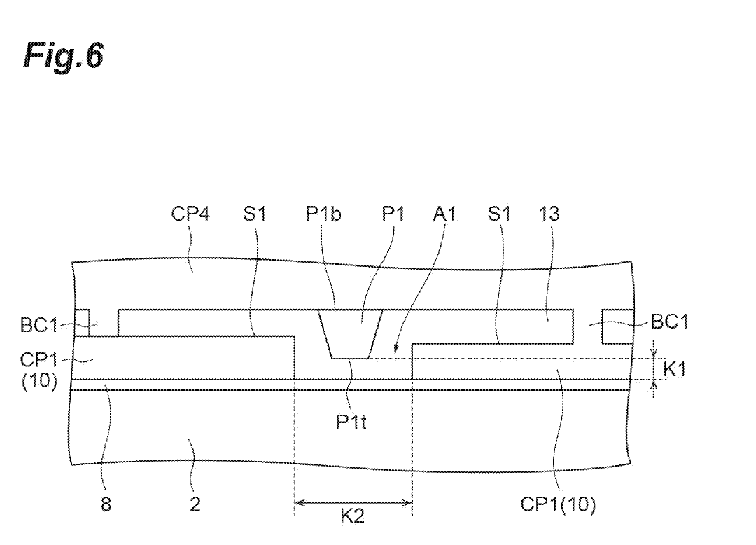

FIG. 6 is an enlarged cross-sectional view illustrating a part of the electronic component 1. In FIG. 6, hatching is omitted. As illustrated in FIG. 6, the first conductor pattern CP1 and the second conductor pattern CP4 are electrically connected by a via conductor (first connection conductor) BC1. A first protruding portion P1 is provided on the second conductor pattern CP4. The first protruding portion P1 has a shape that tapers from a base end P1b toward a distal end P1t. In the present embodiment, the first protruding portion P1 may have, for example, a trapezoidal shape.

The first protruding portion P1 is disposed in the first insulating layer 13 positioned between two adjacent first conductor patterns CP1 and CP1. In the present embodiment, a part of the first protruding portion P1 is positioned between the two adjacent first conductor patterns CP1 and CP1. That is, the distal end P1t of the first protruding portion P1 is positioned at a position closer to the substrate 2 than surfaces S1 of the two first conductor patterns CP1 and CP1. A part of the first protruding portion P1 is disposed in a region A1 between the two adjacent first conductor patterns CP1 and CP1.

A distance K1 between the distal end P1t of the first protruding portion P1 and the substrate 2 (the planar layer 8) is 8 μm or more and 18 μm or less, and is, for example, 15 μm. A distance K2 between the two adjacent first conductor patterns CP1 and CP1 is 15 μm or more and 50 μm or less, and is, for example, 25 μm.

Of the two adjacent first conductor patterns CP1 and CP1, one first conductor pattern CP1 and the other first conductor pattern CP1 constitute different elements, respectively. The different elements may be, for example, an inductor, a capacitor, and the like, or may be a first inductor, a second inductor, and the like of the same inductor.

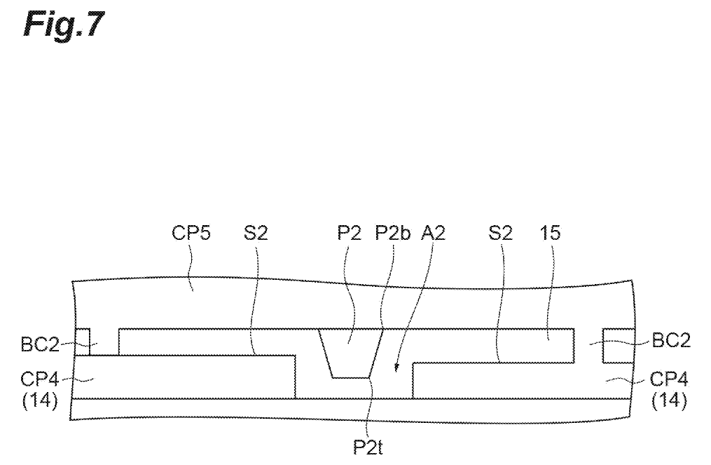

FIG. 7 is an enlarged cross-sectional view illustrating a part of the electronic component 1. In FIG. 7, hatching is omitted. As illustrated in FIG. 7, the second conductor pattern CP4 and the third conductor pattern CP5 are electrically connected by a via conductor (second connection conductor) BC2. A second protruding portion P2 is provided on the third conductor pattern CP5. The second protruding portion P2 has a shape that tapers from a base end P2b toward a distal end P2t. In the present embodiment, the second protruding portion P2 may have, for example, a trapezoidal shape.

The second protruding portion P2 is disposed in the second insulating layer 15 positioned between two adjacent second conductor patterns CP4 and CP4. In the present embodiment, a part of the second protruding portion P2 is positioned between the two adjacent second conductor patterns CP4 and CP4. That is, the distal end P2t of the second protruding portion P2 is positioned at a position closer to the substrate 2 than surfaces S2 of the two second conductor patterns CP4 and CP4. A part of the second protruding portion P2 is disposed in a region A2 between the two adjacent second conductor patterns CP4 and CP4.

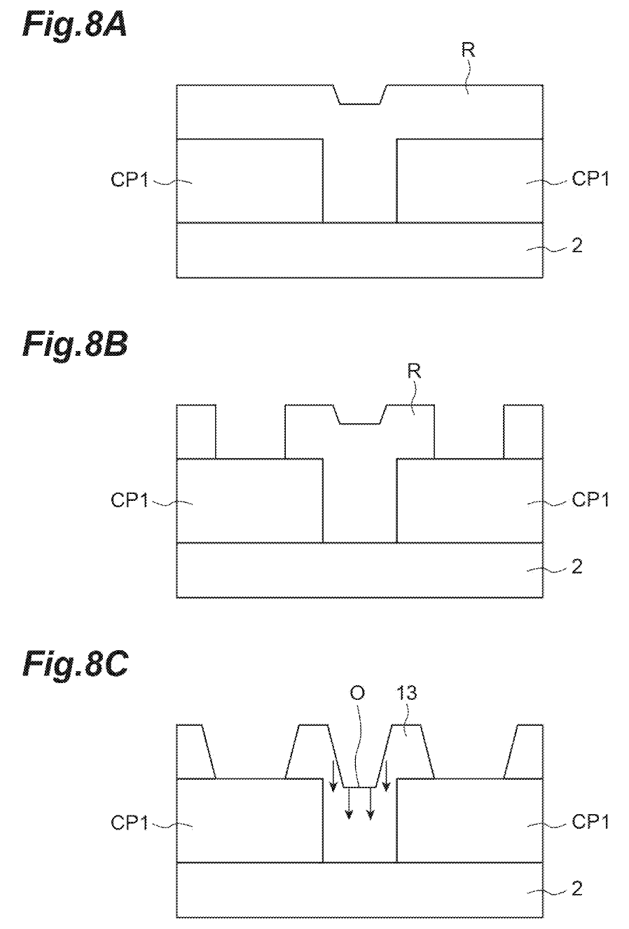

Next, a method of manufacturing the electronic component 1 will be described. FIGS. 8A, 8B, and 8C are views schematically illustrating a part of a manufacturing process of the electronic component 1. As illustrated in FIGS. 8A, 8B, and 8C, in the electronic component 1, when the first protruding portion P1 is formed, a recessed portion O (see FIG. 8C) corresponding to a shape of the first protruding portion P1 is formed in the first insulating layer 13. As illustrated in FIG. 8A, the recessed portion O is formed by applying a resin R onto the first conductor pattern CP1. In a portion of the resin R between the first conductor patterns CP1 and CP1, a recess is formed. Next, as illustrated in FIG. 8B, the resin R is subjected to exposure and development processing.

Next, as illustrated in FIG. 8C, curing processing is performed. That is, after exposure and development of the resin R, curing processing is performed without performing baking processing (without hardening a surface of the resin R). Thereby, shrinkage stress is generated at the surface of the resin R in a direction indicated by the arrows, and the recessed portion O is formed in the first insulating layer 13. Thereafter, a seed layer is formed in the recessed portion O, a plated conductor is formed, and thereby the first protruding portion P1 is formed on the second conductor pattern CP4.

As described above, in the electronic component 1 according to the present embodiment, the first protruding portion P1 of the second conductor pattern CP4 is disposed in the first insulating layer 13 positioned between two adjacent first conductor patterns CP1 and CP1. In this way, in the electronic component 1, since the first protruding portion P1 of the second conductor pattern CP4 is positioned in the first insulating layer 13 between the two adjacent first conductor patterns CP1 and CP1, a volume of the first insulating layer 13 is reduced. Thereby, in the electronic component 1, stress caused by a difference in expansion coefficient between the conductor and the first insulating layer 13 can be reduced. Therefore, in the electronic component 1, peeling of the via conductor BC1, which connects the first conductor pattern CP1 and the second conductor pattern CP4, due to the stress can be suppressed.

In the electronic component 1 according to the present embodiment, the first protruding portion P1 has a shape that tapers from the base end P1b toward the distal end P1t. That is, the first protruding portion P1 is wider on the base end P1b side than on the distal end P1t side. The first protruding portion P1 is formed by forming, in the first insulating layer 13, a recessed portion having a shape corresponding to the first protruding portion P1, forming a seed layer in the recessed portion, and forming a plated conductor on the seed layer. In this manufacturing method, when the first protruding portion P1 is formed to have a shape that tapers from the base end P1b toward the distal end P1t, the recessed portion also has a shape that tapers from an opening toward a bottom surface. In this case, the seed layer is appropriately (uninterruptedly) formed in the recessed portion. Therefore, the first protruding portion P1 is appropriately formed.

In the electronic component 1 according to the present embodiment, at least a part of the first protruding portion P1 is positioned between two adjacent first conductor patterns CP1 and CP1. With this configuration, the volume of the first insulating layer 13 is further reduced. Therefore, in the electronic component 1, peeling of the via conductor BC1, which connects the first conductor pattern CP1 and the second conductor pattern CP4, due to the stress can be suppressed.

In the electronic component 1 according to the present embodiment, the second protruding portion P2 of the third conductor pattern CP5 is disposed in the second insulating layer 15 positioned between two adjacent second conductor patterns CP4 and CP4. With this configuration, peeling of the via conductor BC2, which connects the second conductor pattern CP4 and the third conductor pattern CP5, due to the stress can be suppressed.

Although embodiments of the present disclosure have been described above, the present disclosure is not necessarily limited to the above-described embodiments, and various modifications can be made within a range not departing from the gist of the disclosure.

In the above-described embodiment, a configuration in which the element body 3 includes the first conductor layer 10, the second conductor layer 14, the third conductor layer 16, and the fourth conductor layer 18 has been described as an example. However, the element body 3 only needs to include at least two conductor layers.

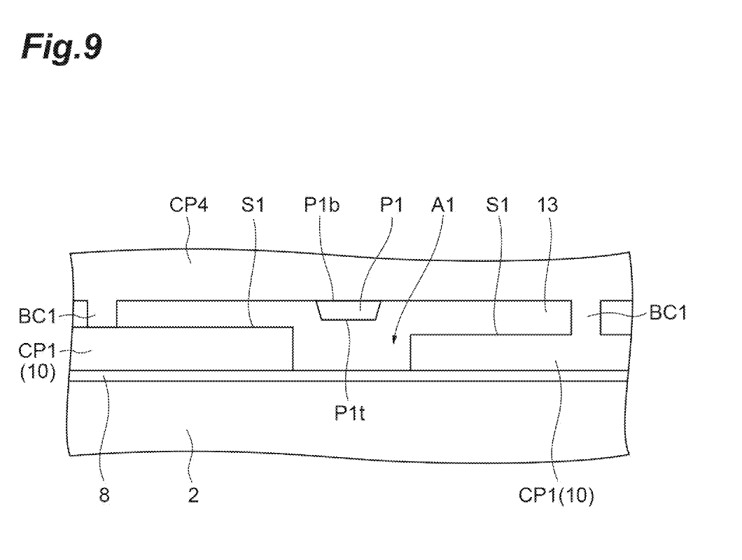

In the above-described embodiment, a configuration in which the distal end P1t of the first protruding portion P1 is positioned at a position closer to the substrate 2 than the surfaces S1 of the two first conductor patterns CP1 and CP1 has been described as an example. However, as illustrated in FIG. 9, the distal end P1t of the first protruding portion P1 may be positioned at a position closer to the second conductor pattern CP4 than the surfaces S1 of the two first conductor patterns CP1 and CP1. The same applies to the second protruding portion P2.

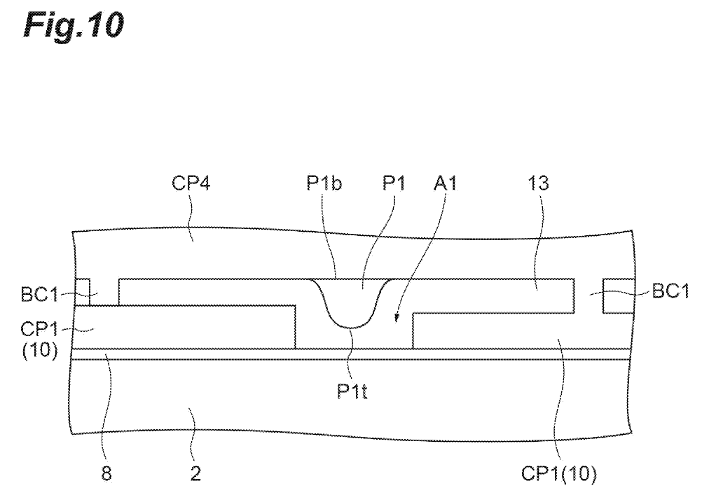

In the above-described embodiment, a configuration in which the first protruding portion P1 has a trapezoidal shape has been described as an example. However, the first protruding portion P1 may have a shape having a curved surface as illustrated in FIG. 10. The same applies to the second protruding portion P2.

What is claimed is:

1. An electronic component comprising:
a substrate; and
an element body disposed on the substrate, wherein
the element body is configured to include a plurality of conductor layers and insulating layers,
the plurality of conductor layers include a first conductor layer disposed on the substrate and a second conductor layer disposed on the first conductor layer,
the first conductor layer includes a plurality of first conductor patterns,
the second conductor layer includes a second conductor pattern,
the first conductor pattern and the second conductor pattern are electrically connected by a first connection conductor,
a first protruding portion is provided in the second conductor pattern, and
the first protruding portion of the second conductor pattern is disposed in the insulating layer positioned between two adjacent first conductor patterns.

2. The electronic component according to claim 1, wherein in the two adjacent first conductor patterns, one first conductor pattern and the other first conductor pattern constitute different elements, respectively.

3. The electronic component according to claim 1, wherein the first protruding portion has a shape that tapers from a base end toward a distal end.

4. The electronic component according to claim 1, wherein at least a part of the first protruding portion is positioned between the two adjacent first conductor patterns.

5. The electronic component according to claim 1, wherein the first protruding portion is formed to have a curved surface.

6. The electronic component according to claim 1, wherein a distance between the first protruding portion and the substrate is 8 μm or more and 18 μm or less.

7. The electronic component according to claim 1, wherein a distance between the two adjacent first conductor patterns is 15 μm or more and 50 μm or less.

8. The electronic component according to claim 1, wherein
the plurality of conductor layers include a third conductor layer disposed on the second conductor layer,
the second conductor layer includes a plurality of second conductor patterns,
the third conductor layer includes a third conductor pattern,
the second conductor pattern and the third conductor pattern are electrically connected by a second connection conductor,
a second protruding portion is provided in the third conductor pattern, and
the second protruding portion of the third conductor pattern is disposed in the insulating layer positioned between two adjacent second conductor patterns.

9. The electronic component according to claim 3, wherein at least a part of the first protruding portion is positioned between the two adjacent first conductor patterns.

10. The electronic component according to claim 4, wherein a distal end of the first protruding portion is positioned on the substrate side with respect to a surface of the first conductor pattern.

11. The electronic component according to claim 1, wherein a distal end of the first protruding portion is positioned on the second conductor layer side with respect to a surface of the first conductor pattern.

12. The electronic component according to claim 8, wherein the second protruding portion has a shape that tapers from a base end toward a distal end.

13. The electronic component according to claim 8, wherein at least a part of the second protruding portion is positioned between the two adjacent second conductor patterns.

14. The electronic component according to claim 8, wherein the second protruding portion is formed to have a curved surface.

15. The electronic component according to claim 1, wherein the insulating layer is formed of a resin including bisphenol F.

16. The electronic component according to claim 1, further comprising a planar layer disposed between the substrate and the element body.

17. The electronic component according to claim 1, further comprising an adhesion layer disposed on the first conductor layer and covering the first conductor pattern.

18. The electronic component according to claim 1, further comprising a capacitor pattern disposed between the first conductor layer and the second conductor layer and constituting a capacitor together with the first conductor pattern.

19. The electronic component according to claim 1, wherein the first connection conductor is a via conductor.

20. The electronic component according to claim 1, wherein the electronic component is a band-pass filter.
